(19) United States
(12) Patent Application Publication
(10) Pub. No.: US 2003/0111649 A1
(43) Pub. Date: Jun. 19, 2003

(54) Chemiluminescent composition for emitting red light

(76) Inventors: Koon Ha Park, Daejeon-City (KR); Yong Rai Kim, Sungnam-City (KR); Yong Fan Kim, Gongju-City (KR); Jong Hoon Baek, Suwon-City (KR)

Correspondence Address: Daniel F. Drexler, 55 Griffin South Road, Bloomfield, CT, 06002, US

(21) Appl. No.: 10/071,764

(22) Filed: Feb. 7, 2002

(30) Foreign Application Priority Data
Oct. 22, 2001 (KR) 2001-65156

(51) Int. Cl. C09K 3/00

(52) U.S. Cl. 252/700

(57) ABSTRACT

The present invention discloses a chemiluminescent composition generating red light comprising a solvent, an oxalate compound and a perylene compound represented by the following formula 2:

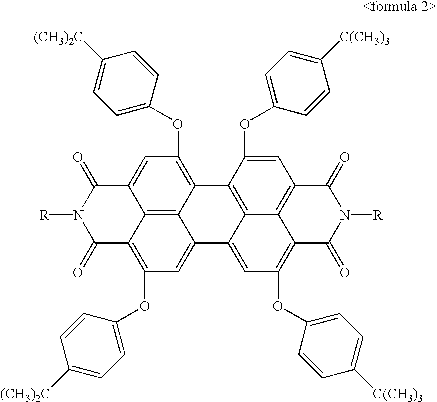

(in which, R is a C₁₂-C₂₀ alkyl group), wherein the perylene compound is present in the composition in an amount of 0.1 to 0.5% by weight, based on the total composition.

### BACKGROUND OF THE INVENTION

1. Field of the Invention

The present invention relates to a chemiluminescent composition, and more particularly to a chemiluminescent composition for emitting red light which exhibits higher intensity and longer lifetime of light than conventional chemiluminescent compositions emitting red light.

2. Description of the Related Art

Red color is generally used for safety and rescue purposes. Thus, there exists a significant demand for chemiluminescent products generating red light. The chemiluminescent products generating such a red light have an intensity and afterglow duration which might be dependent on a fluorescent dye therein.

As fluorescent dyes providing red light, there are known several compounds, which can be generally caused to generate chemiluminescence by a reaction between an oxalate compound and a peroxide component with the dye.

U.S. Pat. No. 3,557,233 discloses the use of derivatives of aromatic compounds (such as naphthacene, tetracene and the like), which are substituted by a phenylethynyl group, as a fluorescent dye providing red light. However, the fluorescent dye disclosed in the above patent has an unsatisfactory light intensity and afterglow duration.

Accordingly, recently, the use of perylenetetracarboxdiimide compound as a dye for oxalate chemiluminescent products is disclosed.

In particular, U.S. Pat. No. 4,845,223 provides a perylenetetracarboxdiimide compound represented by the following formula 1.

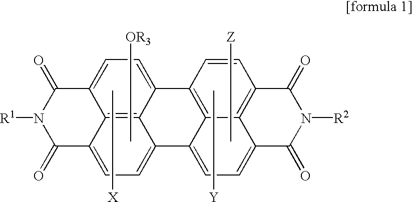

Wherein, R¹ and R² are identical or different, and independently selected from a group consisting of aliphatic, cyclic aliphatic, aromatic, and cyclic aromatic radicals, and X, Y, and Z independently represent chlorine, bromine or OR³, wherein R³ is a substituted or unsubstituted phenyl, naphthyl or anthryl group.

Unfortunately, where a perylenetetracarboxdiimide compound represented by formula 1 is used for chemiluminescent compositions, the most serious problem raised is low solubility in a solvent. In other words, owing to low solubility of the perylenetetracarboxdiimide compound in dibutyl phthalate or dimethyl phthalate, which are generally used as a solvent for chemiluminescent compositions, there are problems in that the initial light intensity is low and the afterglow duration is short.

Accordingly, recent technical developments have been directed toward increasing the solubility of perylenetetracarboxdiimide dye in the above solvents to increase the initial intensity of chemiluminescent light.

As one of such technologies, U.S. Pat. No. 5,122,306 discloses the use of a perylene compound for producing a chemiluminescent composition, which perylene compound is represented by the above formula 1, wherein R¹ and R² are identical, and are a substituted or unsubstituted C₁-C₆ alkyl or phenyl radical, and each of X, Y, and Z is OR³, wherein R³ is a substituted or unsubstituted phenyl group. More particularly, the U.S. patent provides a chemiluminescent composition comprising a perylene compound of the structure described above, a solvent, and an oxalate compound and a method for obtaining a red chemiluminescent light by mixing a solution containing a peroxide component with the composition.

The technology disclosed in U.S. Pat. No. 5,122,306 has an advantage in that the initial intensity and afterglow duration of chemiluminescent light are greatly enhanced by remarkably increasing the solubility of a perylene compound to a solvent, in comparison with conventionally used perylene compounds. However, it also has disadvantages in that the initial intensity of chemiluminescent light is still low. In a chemiluminescent product, the most important thing is the initial intensity up to 2 hours. Strong initial intensity and stable duration are the desirable requirements for products that can be used for longer than 24 hours.

### SUMMARY OF THE INVENTION

Therefore, the present invention has been made in view of the above problems, and it is an object of the present invention to provide a chemiluminescent composition emitting red light, which has very high initial intensity of light and particularly, is applicable to products requiring chemiluminescence lasting more than 24 hours.

It is another object of the present invention to provide a chemiluminescent composition in solution form.

In accordance with one aspect of the present invention, there is provided a chemiluminescent composition generating red chemiluminescence, which comprises a solvent, an oxalate compound and a perylene compound, in which the perylene compound is one represented by formula 2 and present in the composition in an amount of 0.1 to 0.5% by weight, based on the total composition.

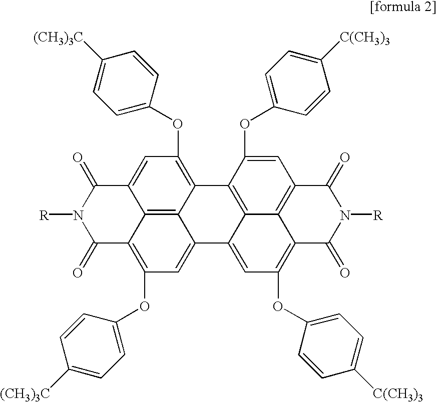

Wherein, R is a C₁₂-C₂₀ alkyl group.

In accordance with another aspect of the present invention, there is provided a chemiluminescent composition containing a solution including a peroxide component and the chemiluminescent composition.

The above and other objects, features and other advantages of the present invention will be more clearly understood from the following detailed description.

### DESCRIPTION OF THE PREFERRED EMBODIMENTS

The present invention pertains to a chemiluminescent composition generating red chemiluminescent light, which comprises a solvent, an oxalate compound and a perylene compound represented by formula 2. The chemiluminescent composition generates red chemiluminescence by reaction with a peroxide component.

In the perylene compound represented by formula 2, R is a C₁₂-C₂₀ alkyl group. In particular, R is preferably a linear alkyl group. The perylene compound having such a long carbon chain alkyl group has much higher initial intensity of chemiluminescent light and higher solubility than conventional perylene compounds, thereby enabling the perylene compound to be used for products requiring long lasting chemiluminescence.

More preferably, the perylene compound of formula 2 is selected from a group consisting of N,N′-didodecyl-1,6,7,12-tetrakis(4-t-butylphenoxy)-3,4,9,10-perylenetetracarboxdiimide, wherein R is a C₁₂ dodecyl group; N,N′-dihexadecyl-1,6,7,12-tetrakis(4-t-butylphenoxy)-3,4,9,10-perylenetetracarboxdiimide, wherein R is a C₁₆ hexadecyl group; and N,N′-dioctadecyl-1,6,7,12-tetrakis(4-t-butylphenoxy)-3,4,9,10-perylenetetracarboxdiimide, wherein R is a C₁₈ octadecyl group.

The perylene compound represented by formula 2 can be synthesized according to conventional processes for providing perylene compounds.

For example, the perylene compound of formula 2 can be obtained easily according to the process as follows; Perylene-3,4,9,10-tetracarboxylic acid dianhydride represented by the following formula 3, an amine compound represented by formula 4, acetic acid and 1-methyl-2-pyrrolidone were mixed under nitrogen atmosphere. The reaction mixture was heated to 90° C. and stirred for six hours. Then, the reaction mixture was cooled to room temperature, stirred for another one hour. The liquid phase was filtered off by suction to yield a solid. The obtained solid was added to aqueous 10% KOH solution, heated to 70° C. and stirred for 30 minutes. The solution was cooled to room temperature and suctioned off again. The residue was washed with excess water and methanol, and dried to obtain a compound represented by formula 5. The obtained compound of formula 5 was refluxed in chloroform for 8 hours while injecting Cl₂ gas. Then, the resulting reaction solution was cooled to room temperature and stirred for 24 hours while feeding air. The solution was then washed twice with saturated aqueous K₂CO₃ solution, and the solvent was distilled off under a reduced pressure. The residue was recrystallized from 1,2-dichloroethane to afford an orange solid represented by formula 6 was obtained. Then, a mixture of the obtained compound of formula 6, 4-t-butylphenol, anhydrous K₂CO₃ and 1-methyl-2-pyrrolidinone was stirred for 8 hours at 120° C. under nitrogen atmosphere. After cooling to room temperature, the reaction mixture was stirred for one hour and filtered. The solid obtained was added to distilled water and stirred for 2 hours at room temperature. Then, the liquid phase was suctioned off again, washed with distilled water and methanol, in order, and dried, by which the perylene compound represented by formula 2 was obtained. 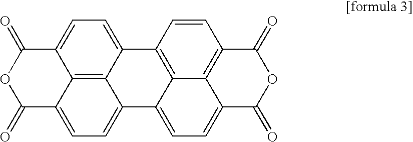 NH₂—R [formula 4]

Wherein, R is a C₁₂-C₂₀ alkyl group.

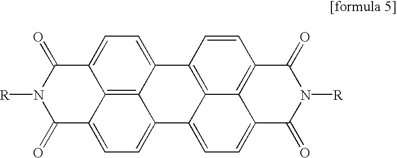

Wherein, R is a C₁₂-C₂₀ alkyl group.

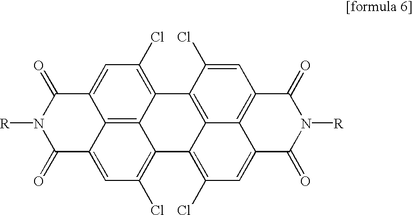

Wherein, R is a C₁₂-C₂₀ alkyl group.

The perylene compound of formula 2 is present in the composition according to the present invention in an amount of, preferably 0.05 to 0.5% by weight, based on the total composition. Where the perylene compound is present in an amount of less than 0.05% by weight, based on the total composition, there is a problem in that the generated light is poor in intensity and duration. Where the perylene compound is present in an amount of more than 0.5%, the perylene compound may be precipitated as a solid. Accordingly, it is preferable that the perylene compound is contained in the prescribed range.

The chemiluminescent composition containing the perylene compound represented by formula 2 also comprises a solvent. The solvent can be selected among common solvents. According to the present invention, the solvent may be one or more selected from a group consisting of tertiary alcohols, dibutyl phthalate and dibutyl benzoate.

The chemiluminescent composition according to the present invention also includes an oxalate compound. Preferably, bis(2,4,5-trichloro-6-carbopentoxyphenyl)oxalate may be used as the oxalate compound.

According to the invention, the oxalate compound is present in the composition in an amount of 5 to 18% by weight, based on the total composition. Where the oxalate compound is present in an amount of less than 5.0% by weight, based on the total composition, the intensity of light will be very low. Where the oxalate compound present in an amount of more than 18%, there will be a problem in that the oxalate compound is precipitated as a solid. Accordingly, it is preferable that the oxalate compound is contained in the prescribed range.

The chemiluminescent composition according to the present invention generates red chemiluminescence by reaction with a peroxide component. Thus, in another aspect of the present invention, it also pertains to a chemiluminescent solution containing the chemiluminescent composition and a solution including a peroxide component. As the solution including a peroxide component, the one that is commonly used in the art can be used.

It is preferable that the solution including a peroxide component contains the peroxide component in an amount of 0.5 to 5% by weight, based on the total solution. Where the peroxide component is present in the solution in an amount of less than 0.5% by weight, based on the total solution, the initial chemiluminescence will be weak. Where the peroxide component is present in an amount of more than 5%, the intensity of initial chemiluminescent light is so high that the duration of chemiluminescence is shorter. Accordingly, it is preferable that the peroxide component is present in the prescribed range. The peroxide component can be hydrogen peroxide, percarboxylic acid and the like, preferably hydrogen peroxide in view of reactivity.

The solution including the peroxide component also includes a solvent. According to the present invention, the solvent is one or more selected from a group consisting of tertiary alcohol, dimethyl phthalate, dibutyl phthalate and dibutyl benzoate.

Further, the solution including the peroxide component may include a catalyst. In the present invention, salicylate may be used as the catalyst. The catalyst is preferably present in the solution in an amount of 0.01 to 0.05% by weight, based on the total solution.

Preferably, the chemiluminescent composition and the solution including the peroxide component are mixed in a ratio of 1:1 to 5:1. Where the ratio of the chemiluminescent composition to the solution including the peroxide component is less than 1:1, the duration of chemiluminescence will be shorter. Where the ratio of the chemiluminescent composition to the solution including the peroxide component is more than 5:1, the initial chemiluminescence is weak. Accordingly, it is preferable that the chemiluminescent composition and the solution including the peroxide component are mixed in the prescribed range.

When the solution including the peroxide component formed as above is mixed with the chemiluminescent composition of the invention in the prescribed ratio, the red chemiluminescence lasts for more than 48 hours, and the afterglow lasts for more than 60 hours.

The chemiluminescent light generated by the present composition can be used in common application fields, for example, for signaling, decoration, games, hunting, fishing or military purposes, as are well known. The chemiluminescent composition also can generate variously colored light by mixing with other fluorescent dyes or ordinary dye. For example, pink chemiluminescent light can be obtained by mixing with a blue fluorescent dye.

Now, preferred embodiments of the present invention will be described in more detail. The following preferred embodiments are described only for a better understanding of the present invention, and are not intended to limit the invention.

### EXAMPLE 1

13.5 g of bis(2,4,5-trichloro-6-carbopentoxyphenyl)oxalate and 86.4 g of dibutyl phthalate were introduced to a flask, heated to 120° C. under nitrogen atmosphere while stirring. Then, 0.100 g of N,N′-didodecyl-1,6,7,12-tetrakis(4-t-butylphenoxy)-3,4,9,10-perylenetetracarboxdiimide was added to the mixture, stirred thoroughly, and cooled to room temperature, by which a chemiluminescent composition was obtained.

### EXAMPLE 2

The procedure of Example 1 was repeated using equivalent molar amounts of N,N′-dihexadecyl-1,6,7,12-tetrakis(4-t-butylphenoxy)-3,4,9,10-perylenetetracarboxdiimide (0.108 g) instead of N,N′-didodecyl-1,6,7,12-tetrakis(4-t-butylphenoxy)-3,4,9,10-perylenetetracarboxdiimide, by which a chemiluminescent composition was obtained.

### EXAMPLE 3

The procedure of Example 1 was repeated using equivalent molar amounts of N,N′-dioctadecyl-1,6,7,12-tetrakis(4-t-butylphenoxy)-3,4,9,10-perylenetetracarboxdiimide (0.113 g) instead of N,N′-didodecyl-1,6,7,12-tetrakis(4-t-butylphenoxy)-3,4,9,10-perylenetetracarboxdiimide, by which a chemiluminescent composition was obtained.

### COMPARISON 1

The procedure of Example 1 was repeated using equivalent molar amounts of N,N′-dibutyl-1,6,7,12-tetrakis(4-t-butylphenoxy)-3,4,9,10-perylenetetracarboxdiimide (0.083 g) instead of N,N′-didodecyl-1,6,7,12-tetrakis(4-t-butylphenoxy)-3,4,9,10-perylenetetracarboxdiimide, by which a chemiluminescent composition was obtained.

### EXPERIMENT 1

To 4.0 g of 60% hydrogen peroxide was added a solution of dimethyl phthalate and t-butyl alcohol (4:1) to a total weight of 100 g. 0.018 g of salicylate was added to the solution to produce a solution including a peroxide component. The obtained solution was mixed with each of chemiluminescent compositions produced from Example 1-3 and Comparison 1 in a ratio of 1:3, and the intensity of light generated was measured at predetermined time intervals by a powermeter (from Coherent Co.; model No.: FM) while all outside light was excluded in a box 28 cm×25 cm×13 cm in size. The results are summarized in Table 1.

TABLE 1

| | Light intensity (nw) according to time (hr) | | | | | | | | | | |
|---|---|---|---|---|---|---|---|---|---|---|---|
| | 0.51 | 1 | 2 | 3 | 4 | 6 | 8 | 10 | 12 | 24 | 48 |
| Example 1 | 873 | 667 | 549 | 443 | 370 | 267 | 201 | 158 | 115 | 59 | 25 |
| Example 2 | 822 | 622 | 525 | 413 | 340 | 262 | 191 | 158 | 125 | 76 | 33 |
| Example 3 | 716 | 569 | 491 | 397 | 310 | 227 | 175 | 148 | 116 | 68 | 31 |
| Comparison 1 | 478 | 429 | 414 | 350 | 300 | 215 | 169 | 136 | 112 | 64 | 27 |

### EXPERIMENT 2

To 4.0 g of 60% hydrogen peroxide was added a solution of dimethyl phthalate and t-butyl alcohol (4:1) to a total weight of 100 g. 0.018 g of salicylate was added to the solution to produce a solution including a peroxide component. The obtained solution was mixed with each of chemiluminescent compositions produced from Example 1-3 and Comparison 1 in a ratio of 1.6:2.4, and the intensity of light generated was measured at predetermined time intervals by a powermeter (from Coherent Co.; model No.: FM) while all outside light was excluded in a box of 28 cm×25 cm×13 cm in size. The results are summarized in following Table 2.

TABLE 2

| | Light Intensity (nw) according to time (hr) | | | | | | | | | | |
|---|---|---|---|---|---|---|---|---|---|---|---|
| | 0.5 | 1 | 2 | 3 | 4 | 6 | 8 | 10 | 12 | 24 | 48 |
| Example 1 | 864 | 688 | 560 | 440 | 331 | 240 | 163 | 118 | 81 | 25 | 5 |
| Example 2 | 810 | 643 | 539 | 429 | 330 | 227 | 161 | 111 | 79 | 24 | 5 |
| Example 3 | 789 | 642 | 531 | 420 | 323 | 222 | 153 | 113 | 81 | 25 | 5 |
| Comparison 1 | 716 | 631 | 552 | 442 | 352 | 239 | 168 | 121 | 87 | 28 | 6 |

### EXPERIMENT 3

To 4.0 g of 60% hydrogen peroxide was added a solution of dimethyl phthalate and t-butyl alcohol (4:1) to a total weight of 100 g. 0.018 g of salicylate was added to the solution to produce a solution including a peroxide component. The obtained solution was mixed with each of chemiluminescent compositions produced from Example 1-3 and Comparison 1 in a ratio of 1.7:2.6, and the intensity of light generated was measured at predetermined time intervals by a powermeter (from Coherent Co.; model No.: FM) while all outside light was excluded in a box of 28 cm×25 cm×13 cm in size. The results are summarized in following Table 3.

TABLE 3

| | Light Intensity (nw) according to time (hr) | | | | | | | | | | |
|---|---|---|---|---|---|---|---|---|---|---|---|
| | 0.5 | 1 | 2 | 3 | 4 | 6 | 8 | 10 | 12 | 24 | 48 |
| Example 1 | 844 | 657 | 480 | 403 | 361 | 261 | 192 | 142 | 113 | 45 | 29 |
| Example 2 | 773 | 641 | 459 | 374 | 367 | 284 | 220 | 184 | 143 | 58 | 33 |
| Example 3 | 745 | 580 | 500 | 364 | 359 | 263 | 206 | 146 | 113 | 47 | 31 |
| Comparison 1 | 587 | 498 | 422 | 377 | 358 | 283 | 231 | 165 | 132 | 55 | 30 |

As shown from the Table 1 to Table 3, it is found that chemiluminescent compositions formed according to the invention, respectively, are superior to conventional chemiluminescent compositions in view of the initial light intensity and afterglow duration, as a result of measuring light intensity while varying the mixing ratio of each of chemiluminescent compositions and a solution including a peroxide component.

As described above, the present invention can provide a chemiluminescent composition, which has excellent stability compared with conventional chemiluminescent compositions generating red light, and which has strong initial light intensity and long afterglow duration, and a chemiluminescent solution based on the composition.

What is claimed is:

1. A chemiluminescent composition emitting red light comprising a solvent, an oxalate compound and a perylene compound represented by the following formula 2: 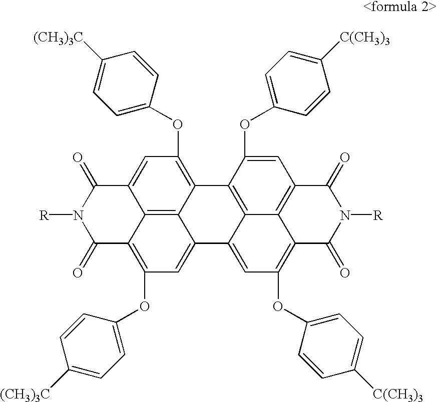
in which, R is a C₁₂-C₂₀ alkyl group, wherein the perylene compound is present in the composition in an amount of 0.1 to 0.5% by weight, based on the total composition.

2. The chemiluminescent composition as set forth in claim 1, wherein the perylene compound represented by formula 2 is selected from the group consisting of N,N′-didodecyl-1,6,7,12-tetrakis(4-t-butylphenoxy)-3,4,9,10-perylene tetracarboxdiimide, N,N′-dihexadecyl-1,6,7,12-tetrakis(4-t-butylphenoxy)-3,4,9,10-perylenetetracarboxdiimide, and N,N′-dioctadecyl-1,6,7,12-tetrakis(4-t-butylphenoxy)-3,4,9,10-perylenetetracarboxdiimide.

3. The chemiluminescent composition as set forth in claim 1, wherein the oxalate compound is bis(2,4,5-trichloro-6-carbopentoxyphenyl)oxalate.

4. The chemiluminescent composition as set forth in claim 1, wherein the oxalate compound is present in the composition in an amount of 5 to 18% by weight, based on the total composition.

5. The chemiluminescent composition as set forth in claim 1, wherein the solvent is selected from the group consisting of dibutyl phthalate, dibutyl benzoate and mixtures thereof.

6. A chemiluminescent composition comprising a solvent, an oxalate compound, a perylene compound represented by the following formula 2, and a peroxide component: 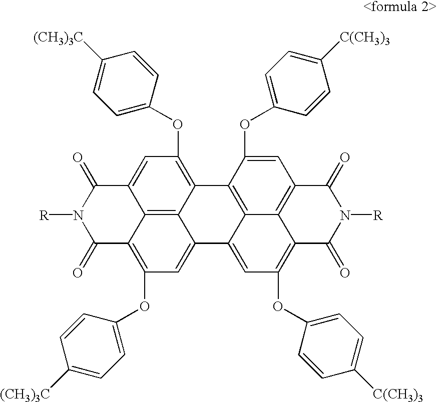
in which, R is a C₁₂-C₂₀ alkyl group, wherein the perylene compound is present in the composition in an amount of 0.1 to 0.5% by weight, based on the total composition.

7. The chemiluminescent composition as set forth in claim 6, wherein the peroxide component is included in a solution form in the composition.

8. The chemiluminescent composition as set forth in claim 7, wherein the solution of the peroxide component includes the peroxide in an amount of 1 to 5% by weight, based on the solution.

9. The chemiluminescent composition as set forth in claim 7, wherein the solution of the peroxide component contains a solvent.

10. The chemiluminescent composition as set forth in claim 9, wherein the solvent is selected from the group consisting of dibutyl phthalate, dimethyl phthalate, dibutyl benzolate, and mixtures comprising at least one of foregoing.

11. The chemiluminescent composition as set forth in claim 7, wherein the solution including the peroxide component contains a catalyst.

12. The chemiluminescent composition as set forth in claim 11, wherein the catalyst is salicylate.

13. The chemiluminescent composition as set forth in claim 11, wherein the catalyst is contained in an amount of 0.001 to 0.05% by weight, based on the total solution of the peroxide component.
